(19) United States
(12) Patent Application Publication
(10) Pub. No.: US 2012/0298931 A1
(43) Pub. Date: Nov. 29, 2012

(54) VISCOSITY MODIFIER COMPOSITIONS AND METHODS

(75) Inventor: Richard R. Ollmann, Woodbury, MN (US)

(73) Assignee: Carestream Health Inc.

(21) Appl. No.: 13/450,557

(22) Filed: Apr. 19, 2012

Related U.S. Application Data
(60) Provisional application No. 61/488,855, filed on May 23, 2011.

(51) Int. Cl. H01B 1/22; B82Y 30/00

(52) U.S. Cl. 252/514; 977/762

(57) ABSTRACT

Disclosed are conductive coatings that exhibit improved clarity, uniformity, and mechanical strength. Such coatings comprising volatile viscosity modifiers are useful for electronics applications.

### CROSS REFERENCE TO RELATED APPLICATIONS

This application claims the benefit of U.S. provisional application No. 61/488,855, filed May 23, 2011, entitled VISCOSITY MODIFIER COMPOSITIONS AND METHODS, which is hereby incorporated by reference in its entirety.

### BACKGROUND

Viscosity modifiers comprising amine-acid adducts are described in US patent publication 2005/0276924. Application of such viscosity modifiers to compositions comprising conductive nanomaterials is described in US patent publication 2009/0035707.

### SUMMARY

Some embodiments provide compositions comprising at least one conductive nanomaterial, at least one first compound comprising at least one carbamic acid or carbamate moiety and at least one second compound comprising at least one ester linkage and at least one hydroxyl moiety, where the at least one first compound is more volatile than the at least one second compound. The at least one conductive nanomaterial may, for example, comprise one or more nanowires, nanocubes, nanopyramids, nanotubes, or the like. The at least one conductive nanomaterial may, for example, comprise at least one coinage metal or at least one silver nanowire. In at least some embodiments, the at least one first compound comprises ten or fewer carbons, or it comprises a single carbamic acid or carbamate moiety, or it may, for example, comprise (butan-2-yl)carbamic acid. In at least some embodiments, the at least one second compound comprises four or more carbon atoms, or it comprises at least one lactate moiety, or it may, for example, comprise ethyl lactate.

Other embodiments provide methods comprising introducing dry ice to a vessel, forming in the vessel at least one first compound comprising at least one carbamic acid or carbamate moiety, and contacting the at least one first compound with a conductive nanomaterial and at least one second compound comprising at least one ester linkage.

These embodiments are other variations and modifications may be better understood from the brief description of figures, description, figures, exemplary embodiments, examples, and claims that follow. Any embodiments provided are given only by way of illustrative example. Other desirable objectives and advantages inherently achieved may occur or become apparent to those skilled in the art.

### BRIEF DESCRIPTION OF FIGURES

FIG. 1 shows a transmission micrograph at 400 power of the coating of Example 1.

FIG. 2 shows a reflection micrograph at 400 power of the coating of Example 1.

FIG. 3 shows a reflection micrograph at 80 power of the coating of Example 1.

FIG. 4 shows a reflection micrograph at 400 power of the coating of Example 3.

FIG. 5 shows a transmission micrograph at 400 power of the coating of Example 3.

### DESCRIPTION

All publications, patents, and patent documents referred to in this document are incorporated by reference herein in their entirety, as though individually incorporated by reference.

U.S. provisional application No. 61/488,855, filed May 23, 2011, entitled VISCOSITY MODIFIER COMPOSITIONS AND METHODS, is hereby incorporated by reference in its entirety.

Compositions comprising conductive nanoconductors, such as, for example, silver nanowires, may be applied to substrates as coatings. In order to provide conductive coatings, the nanoconductors may be distributed throughout the coating, such as, for example, in a uniform manner. Such distribution may be enhanced by providing one or more binders in one or more carriers. Such binders may have sufficient viscosity and be present in high enough concentration to reduce or prevent settling of the nanoconductors during or subsequent to coating the substrates. However, such binders should not be present in high enough concentration in the final coating to reduce its conductivity so as to render the coating unfit for use in, for example, an electronic device.

Binders may comprise viscosity modifiers that are capable of being volatilized during or subsequent to coating the substrates. An example of such viscosity modifiers are compositions comprising one or more carbamic acid or carbamate moieties, such as, for example, (butan-2-yl)carbamic acid. Such compositions may be formed by reaction of amines, such as, for example, secondary amines, with carbon dioxide, provided in, for example, gaseous or solid form. Such viscosity modifiers may be used in sufficient concentration to address coating needs and then may be partially or wholly removed from the coating layer by volatilization, thereby improving the coating conductivity.

The Applicant has discovered that binders comprising such viscosity modifiers may provide coatings that are hazy, or coatings that lack uniformity, or coatings that lack mechanical strength. The use of compounds comprising at least one ester linkage and at least one hydroxyl moiety, such as, for example, ethyl lactate, in combination with these viscosity modifiers, can provide conductive coatings with improved clarity, uniformity, and mechanical strength.

### EXEMPLARY EMBODIMENTS

U.S. provisional application No. 61/488,855, filed May 23, 2011, entitled VISCOSITY MODIFIER COMPOSITIONS AND METHODS, which is hereby incorporated by reference in its entirety, disclosed the following 11 non-limiting exemplary embodiments:

A. A composition comprising:

at least one conductive nanomaterial,

at least one first compound comprising at least one carbamic acid or carbamate moiety, and

at least one second compound comprising at least one ester linkage and at least one hydroxyl moiety,

wherein the at least one first compound is more volatile than the at least one second compound.

B. The composition according to embodiment A, wherein the at least one conductive nanomaterial comprises one or more nanowires, nanocubes, nanorods, nanopyramids, or nanotubes.
C. The composition according to embodiment A, wherein the at least one conductive nanomaterial comprises at least one coinage metal.
D. The composition according to embodiment A, wherein the at least one conductive nanomaterial comprises at least one silver nanowire.
E. The composition according to embodiment A, wherein the at least one first compound comprises ten or fewer carbon atoms.
F. The composition according to embodiment A, wherein the at least one first compound comprises a single carbamic acid or carbamate moiety.
G. The composition according to embodiment A, wherein the at least one first compound comprises (butan-2-yl)carbamic acid.
H. The composition according to embodiment A, wherein the at least one second compound comprises four or more carbon atoms.
J. The composition according to embodiment A, wherein the at least one second compound comprises at least one lactate moiety.
K. The composition according to embodiment A, wherein the at least one second compound comprises ethyl lactate.
L. A method comprising:

introducing dry ice to a vessel;

forming in the vessel at least one first compound comprising at least one carbamic acid or carbamate moiety; and

contacting the at least one first compound with a conductive nanomaterial and at least one second compound comprising at least one ester linkage and at least one hydroxyl moiety.

### EXAMPLES

### Example 1

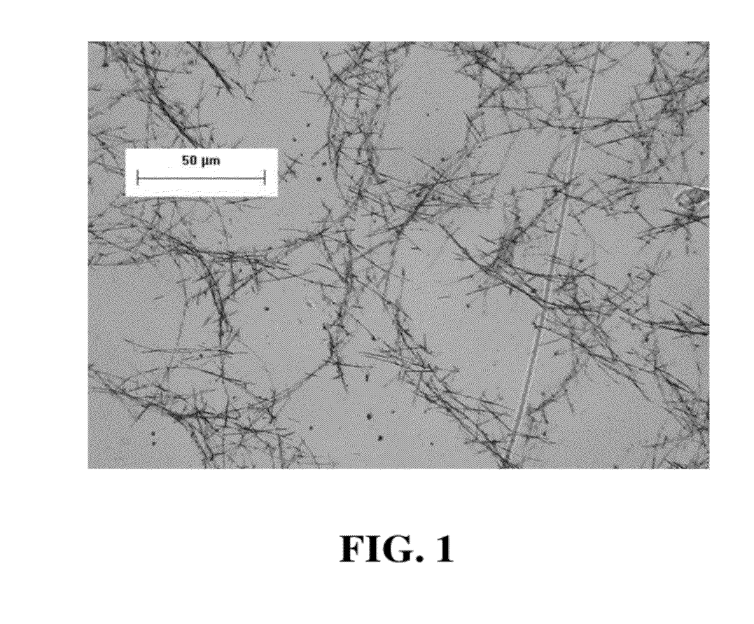

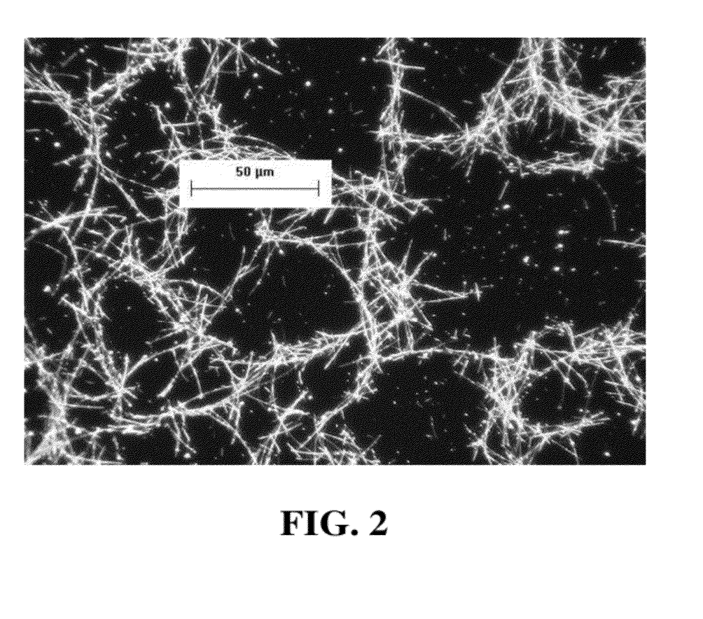

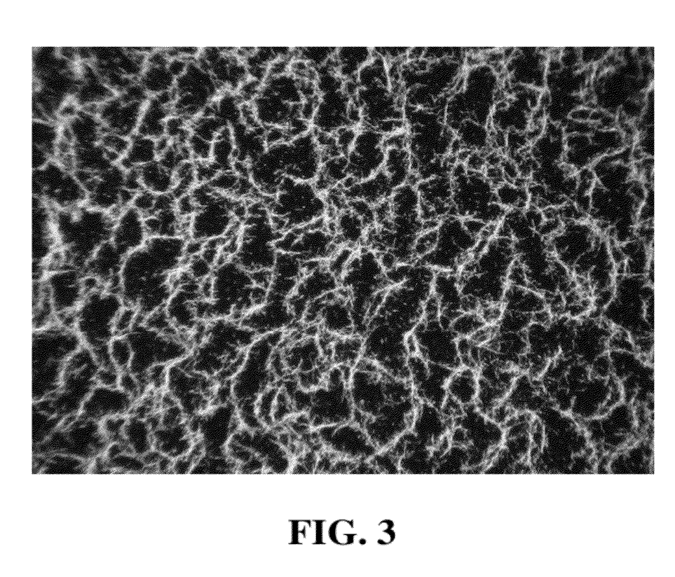

In a vial, 2.0 g ethyl lactate, 2.0 g sec-butyl amine, and 1.0 g water were mixed. 3.6 g dry ice was added slowly to the vial with mixing. The viscous mixture was allowed to come to room temperature, aided by an exotherm, after which 4.0 g isopropanol and 0.5 g of a 2.7 wt % suspension of silver nanowires in isopropanol were added. The resulting coating composition was wire coated on a polyethylene terephthalate substrate using a #14 wire-wrapped rod. The coated substrate was oven dried to give a hazy coating with a surface resistivity that ranged from 50 to 100 ohms/square, as measured with an R-CHEK™ RC2175 four-point surface resistivity meter. Examination of the coating with an optical microscope showed a network of nanowires, as illustrated in FIGS. 1-3. The coating was easily wiped off of the substrate.

### Example 2

To a 2.81 g sample of the coating composition of Example 1, 2.0 g of ethyl lactate and 0.8 g of a 2.7 wt % suspension of silver nanowires in isopropanol were added. The resulting composition was coated on a polyethylene terephthalate substrate using a #16 wire-wrapped rod. The resulting coating was more uniform than the coating of Example 1 and had fewer visible patterns.

### Example 3

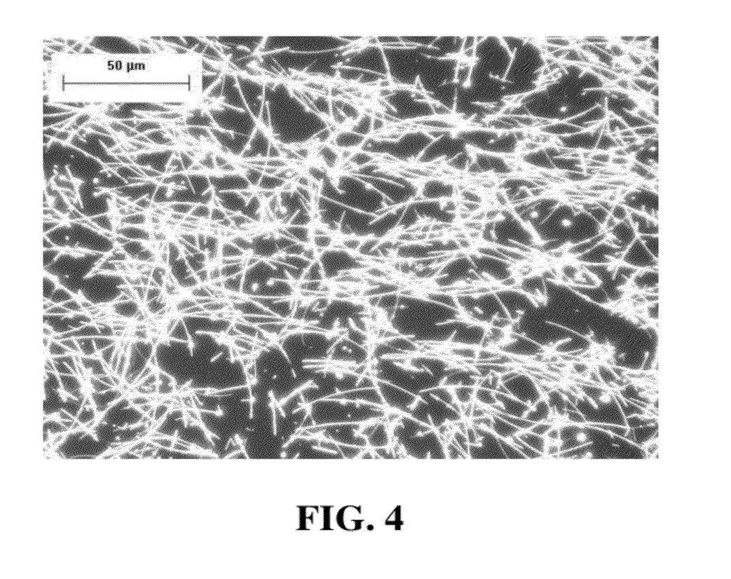

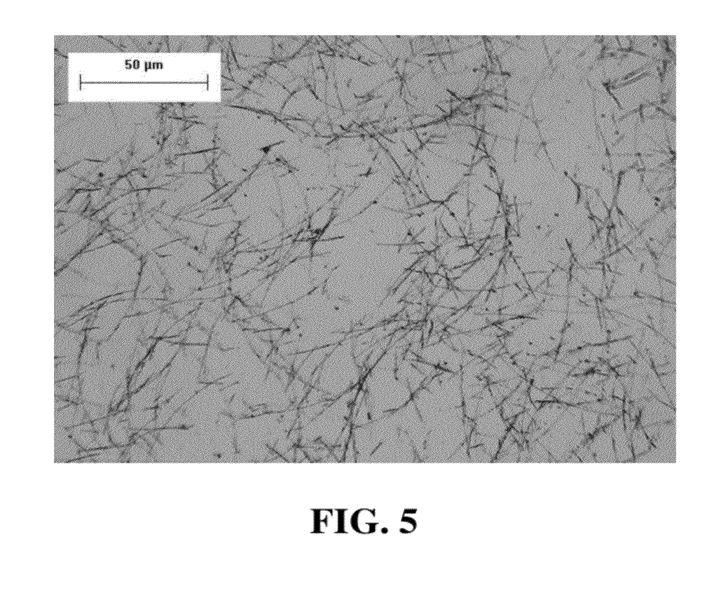

To a vial filled with dry ice were slowly added 4.0 g ethyl lactate, 2.0 g sec-butyl amine, 1.0 g water, and 4.0 g isopropanol. The mixture was allowed to increase in temperature, due to an exotherm, then cool due to an excess of dry ice being present, and then warm to room temperature over the course of about 50 min. 1.3 g of a 2.7 wt % suspension of silver nanowires in isopropanol was then added and mixed into the mixture. The resulting composition was coated on a polyethylene terephthalate substrate using a #9 wire-wrapped rod. The resulting coating was dried for 1 min at 110° C. to give a uniform coating with surface resistance that ranged from 200 to 400 ohms/square. The resulting coating was more uniform and the wires more uniformly distributed than the coating of Example 1, as shown in FIGS. 4-5.

The invention has been described in detail with reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

What is claimed:

1. A composition comprising:
at least one conductive nanomaterial,
at least one first compound comprising at least one carbamic acid or carbamate moiety, and
at least one second compound comprising at least one ester linkage and at least one hydroxyl moiety,
wherein the at least one first compound is more volatile than the at least one second compound.

2. The composition according to claim 1, wherein the at least one conductive nanomaterial comprises one or more nanowires, nanocubes, nanorods, nanopyramids, or nanotubes.

3. The composition according to claim 1, wherein the at least one conductive nanomaterial comprises at least one coinage metal.

4. The composition according to claim 1, wherein the at least one conductive nanomaterial comprises at least one silver nanowire.

5. The composition according to claim 1, wherein the at least one first compound comprises ten or fewer carbon atoms.

6. The composition according to claim 1, wherein the at least one first compound comprises a single carbamic acid or carbamate moiety.

7. The composition according to claim 1, wherein the at least one first compound comprises (butan-2-yl)carbamic acid.

8. The composition according to claim 1, wherein the at least one second compound comprises four or more carbon atoms.

9. The composition according to claim 1, wherein the at least one second compound comprises at least one lactate moiety.

10. The composition according to claim 1, wherein the at least one second compound comprises ethyl lactate.
